(19) United States
(12) Patent Application Publication
(10) Pub. No.: US 2026/0124923 A1
(43) Pub. Date: May 7, 2026

(54) SYSTEM AND METHOD FOR MOTOR BASED POWER TRANSFER

(71) Applicant: GM GLOBAL TECHNOLOGY OPERATIONS LLC, Detroit, MI (US)

(72) Inventors: Peng Peng, Rochester Hills, MI (US); Lei Hao, Troy, MI (US); Thomas W. Nehl, Shelby Township, MI (US); Suresh Gopalakrishnan, Troy, MI (US); Renato Amorim Torres, Pontiac, MI (US)

(73) Assignee: GM GLOBAL TECHNOLOGY OPERATIONS LLC, Detroit, MI (US)

(21) Appl. No.: 18/935,786

(22) Filed: Nov. 4, 2024

(51) Int. Cl. B60L 1/00; B60L 15/00; B60L 50/60; H02K 3/04; H02P 27/06

(52) U.S. Cl. CPC B60L 1/006; B60L 15/007; B60L 50/60; H02K 3/04; H02P 27/06; B60L 2220/54

(57) ABSTRACT

A power transfer system includes a traction battery pack, a power inverter module configured electrical communication with the traction battery pack, and a rotary electric machine. The rotary electric machine is in electrical communication with the alternating current bus and includes a first set of windings in electrical communication with the alternating current bus and a second set of winding in electrical communication with an output alternating current bus. A power outlet in electrical communication with the second set of windings through the output alternating current bus. A controller in electrical communication with the power inverter module. The controller is configured to selectively direct the power inverter module to direct the alternating current through the alternating current bus to the rotary electric machine to generate a desired output power at the power outlet.

### BACKGROUND

Fully electric or hybrid electric vehicles are capable of achieving greater range through advancements in battery technology and capacity. Certain batteries, such as traction batteries, provide power in the form of direct current (“DC”). The DC power from the traction battery can be converted to alternative current (“AC”) by a power module to drive a traction motor or operate another portion of the vehicle. As the traction batteries can store large amounts of power, utilizing a portion of that power for purposes other than propulsion can be beneficial. For example, a user of the vehicle may want to power small electronic devices when in remote areas, to provide power to a home during a power outage, or to provide power directly to a grid. In one example, to convert the DC power from the traction battery to power that can be utilized by other sources, a second power module is linked to the traction battery separate from the power module used to drive the traction motor.

### SUMMARY

Disclosed herein is a power transfer system. The system includes a traction battery pack, a power inverter module configured to receive a high-voltage direct current from the traction battery pack and convert the high-voltage direct current into an alternating current that is configured to be received by an alternating current bus, and a rotary electric machine. The rotary electric machine is in electrical communication with the alternating current bus and is a segmented winding machine that includes a first set of windings in electrical communication with the alternating current bus and a second set of winding in electrical communication with an output alternating current bus. A power outlet in electrical communication with the second set of windings through the output alternating current bus. A controller in electrical communication with the power inverter module. The controller is configured to selectively direct the power inverter module to direct the alternating current through the alternating current bus to the rotary electric machine to generate a desired output power at the power outlet.

In one aspect of the disclosure the first set of windings are low-turn windings and the second set of windings are high-turn windings.

In one aspect of the disclosure the first set of windings are located radially inward from the second set of windings in a stator of the rotary electric machine relative to an axis of rotation of a rotor in the rotary electric machine.

In one aspect of the disclosure the second set of windings includes three sets of windings each having a corresponding output in electrical communication with the output alternating current bus.

In one aspect of the disclosure a single set of winding of the three sets of windings is selectively connectable to the power outlet by a switch for providing one of a three-phase alternating current or a single-phase alternating current to the power outlet.

In one aspect of the disclosure the desired output power includes a three-phase alternating current and the controller is configured to disengage a drivetrain from the rotary electric machine. In one aspect of the disclosure the rotor is an eight pole rotor and the controller is configured to direct the rotary electric machine to rotate the rotor at 900 RPM.

In one aspect of the disclosure the rotor is a six pole rotor and the controller is configured to direct the rotary electric machine to rotate the rotor at 1200 RPM.

In one aspect of the disclosure the desired output power includes a single phase alternating current and the second set of windings includes two sets of windings.

In one aspect of the disclosure the second set of windings include between 8 and 10 times as many turns as the first set of windings.

Disclosed herein is a method of performing power transfer. The method includes directing a power inverter module to convert direct current from a traction battery pack from a direct current bus into a three-phase alternating current received by an alternating current bus. Th method also includes directing the three-phase alternating current into a rotary electric machine. The rotary electric machine is a segmented winding machine and includes a first set of windings in electrical communication with the alternating current bus and a second set of winding in electrical communication with an output alternating current bus. The method also includes directing an alternating current generated in the second set of windings through the output alternating current bus to a power outlet.

In one aspect of the disclosure the first set of windings are low-turn windings and the second set of windings are high-turn windings and the first set of windings are located radially inward from the second set of windings.

In one aspect of the disclosure the second set of windings include three sets of windings configured to provide three-phase alternating current from the second set of windings to the output alternating current bus.

In one aspect of the disclosure the method includes directing a rotational speed of a rotor in the rotary electric machine to synchronize a frequency, amplitude, and phase of the alternating current generated in the second set of windings with a load in electrical communication with the power outlet.

In one aspect of the disclosure the method includes disengaging the rotary electric machine from a drivetrain of a vehicle when directing the rotational speed of the rotor in the rotary electric machine to synchronize the frequency, amplitude, and phase of the alternating current generated in the second set of windings with the load in electrical communication with the power outlet.

In one aspect of the disclosure the second set of windings include three sets of windings each having a corresponding output and one of the three sets of windings is selectively connectable to the power outlet for generating one of single-phase alternating current or three-phase alternating current.

Disclosed herein is a vehicle. The vehicle includes a vehicle body supported by wheels, a traction battery pack fixed relative to the vehicle body, and a power inverter module configured to receive a high-voltage direct current from the traction battery pack and convert the high-voltage direct current into an alternating current that is configured to be received by an alternating current bus. The vehicle also includes a rotary electric machine in electrical communication with the alternating current bus and configured to drive the wheels through a drivetrain. The rotary electric machine is a segmented winding machine and includes a first set of windings in electrical communication with the alternating current bus and a second set of winding in electrical communication with an output alternating current bus. The vehicle also includes a power outlet in electrical communication with the second set of windings through the output alternating current bus and a controller in electrical communication with the power inverter module. The controller is configured to selectively direct the power inverter module to direct the alternating current through the alternating current bus to the rotary electric machine to generate a desired output power at the power outlet.

In one aspect of the disclosure the first set of windings are low-turn windings and the second set of windings are high-turn windings.

In one aspect of the disclosure the second set of windings includes three sets of windings each having a corresponding output in electrical communication with the output alternating current bus.

In one aspect of the disclosure a single set of winding of the three sets of windings is selectively connectable to the power outlet by a switch for providing one of a three-phase alternating current or a single-phase alternating current to the power outlet.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 is a plan view illustration of a vehicle, and a battery system coupled to an Electronic Control Unit (ECU) and a power inverter module (PIM) in which the principles of the present disclosure may be implemented.

FIG. 2 is a schematic illustration of generating three-phase alternating current with a traction motor from the vehicle of FIG. 1.

FIG. 3 is a schematic illustration of generating single-phase alternating current with a traction motor of FIG. 1.

FIG. 4 is a schematic illustration of generating single-phase alternating current with the traction motor from the vehicle of FIG. 1.

FIG. 5 is a flow diagram of a method of generating output power with the traction motor of FIG. 1.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

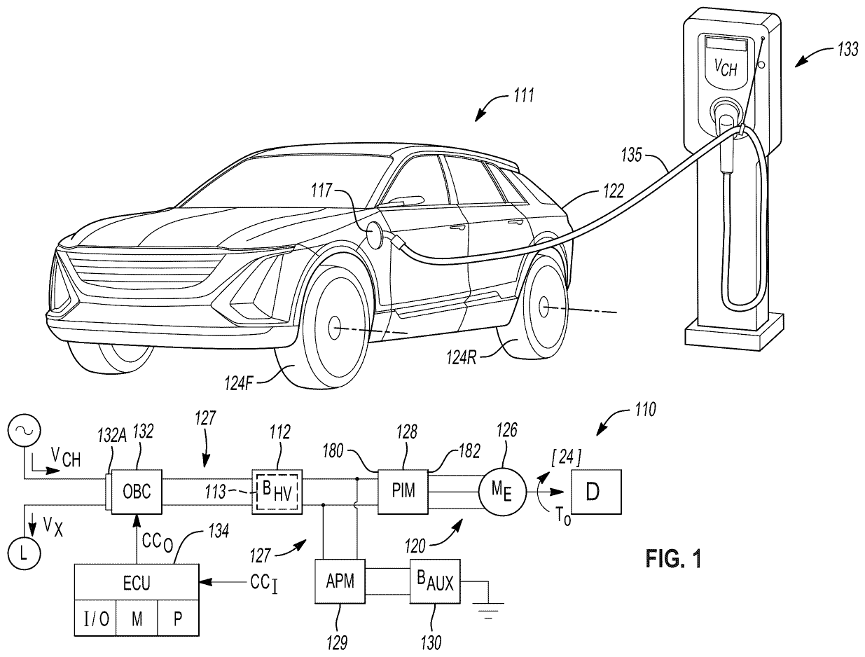

While the principles of the present disclosure have wide application to diverse architectures, for purposes of example, electric vehicles are considered. To that end, FIG. 1 is a plan view illustration of a vehicle and a battery system coupled to an Electronic Control Unit (ECU) and a power inverter module (PIM) in which the principles of the present disclosure may be implemented. In the embodiment of FIG. 1, an ECU controls various operations of the vehicle.

While an electric vehicle is shown in FIG. 1, it will be appreciated that the disclosure is not so limited to a vehicle having the appropriate programmed circuitry. While the above hysteresis models may apply to a number of different physical configurations, FIG. 1 shows one such example. FIG. 1 depicts an electrified powertrain system 110 having a high-voltage battery pack (BHV) 112, such as a traction battery pack. In a non-limiting example, the battery pack 112 may be embodied as a high-capacity battery having a voltage capability of about 400-800 volts or more, with the actual voltage capability of the battery pack 112 provided based on a desired operating/SOC range, gross weight, and power rating of a load connected to the battery pack 112. In a possible construction, the battery pack 112 may be a propulsion battery pack generally composed of an array of lithium-ion or lithium-ion polymer rechargeable electrochemical battery cells, which may be a cylindrical battery cell. The present teachings may also be applied to prismatic battery cells, and to pouch-style battery cells in possible configurations, and thus the cylindrical battery cell is exemplary without being limiting.

Although internal details of the battery cells in battery pack 112 are omitted for illustrative simplicity, those skilled in the art will appreciate that the battery cells contain within the cell cavity an electrolyte material, working electrodes in the form of a cathode and an anode, and a permeable separator (not shown), which are collectively enclosed inside an electrically insulated can or casing. Grouped battery cells may be connected in series or parallel through use of an electrical interconnect board and related buses, sensing hardware, and power electronics (not shown but well understood in the art). An application-specific number of the battery cells in battery pack 112 may be arranged relative to the battery tray 113 in columns and rows. In a nominal “xyz” Cartesian reference frame, for instance, the battery tray 113 when viewed from above or below may have a length (x-dimension) and a width (y-direction), with a height (z-dimension) extending in an orthogonal direction away from the battery tray 113.

In a representative use case, the electrified powertrain system 110 may be used as part of an EV 111 or another mobile system. As shown, the EV 111 may be embodied as a battery electric vehicle, with the present teachings also being extendable to plug-in hybrid electric vehicles. Alternatively, the electrified powertrain system 110 may be used as part of another mobile system such as but not limited to a rail vehicle, aircraft, marine vessel, robot, farm equipment, etc. Likewise, the electrified powertrain system 110 may be stationary, such as in the case of a powerplant, hoist, drive belt, or conveyor system. Therefore, the electrified powertrain system 110 in the representative vehicular embodiment of FIG. 1 is intended to be illustrative of the present teachings and not limiting thereof.

The EV 111 shown in FIG. 1 includes a vehicle body 122. The vehicle body 122 may include a frame within the body 122 to define areas for placement of mechanical and electrical components, as well as a passenger cabin. The EV may further include road wheels 124F and 124R, with “F” and “R” indicating the respective front and rear positions. The road wheels 124F and 124R rotate about respective axes, with the road wheels 124F, the road wheels 124R, or both being powered by output torque (arrow T_{O}) from a rotary electric machine (M_{E}) 126, such as a segmented winding machine, of the electrified powertrain system 110 as indicated by arrow [24] through a drivetrain D. The road wheels 124F and 124R thus represent a mechanical load in this embodiment, with other possible mechanical loads being possible in different host systems. To that end, the electrified powertrain system 110 includes a power inverter module (PIM) 128 (also referenced herein as a power module (PM)) and the high-voltage battery pack 112, e.g., a multi-cell lithium-ion propulsion battery or a battery having another application-suitable chemistry, both of which are arranged on a high-voltage DC bus 127. As appreciated in the art, the PIM 128 includes a DC side 180 and an alternating current (AC) side 182, with the latter being connected to individual phase windings (not shown) of the rotary electric machine 126 when the rotary electric machine 126 is configured as a polyphase rotary electric machine in the form of a propulsion or traction motor as shown.

The battery pack 112 of FIG. 1 in turn is connected to the DC side 180 of the PIM 128, such that a battery voltage from the battery pack 112 is provided to the power inverter module (PIM) 128 during propulsion modes of the EV 111. The PIM 128, or more precisely a set of semiconductor switches (not shown) residing therein, are controlled via pulse width modulation (PWM), pulse density modulation (PDM), or other suitable switching control techniques to invert a DC input voltage on the DC bus 127 into an AC output voltage suitable for energizing a high-voltage AC bus 120. As noted, the PIM 128 may also be referred to simply as a power module (PM), which may include an inverter or converter. High-speed switching of the resident semiconductor switches of the PIM 128 energizes the rotary electric machine 126 to thereby cause the rotary electric machine 126 to deliver the output torque (arrow T_{O}) as a motor drive torque to one or more of the road wheels 124F and/or 124R in another coupled mechanical load in other implementations.

Electrical components of the electrified powertrain system 110 may also include an accessory power module (APM) 129 and an auxiliary battery (B_{AUX}) 130. The APM 129 is configured as a DC-DC converter that is connected to the DC bus 127, as appreciated in the art. In operation, the APM 129 is capable, via internal switching and voltage transformation, of reducing a voltage level on the DC bus 127 to a lower level suitable for charging the auxiliary battery 130 and/or supplying low-voltage power to one or more accessories (not shown) such as lights, displays, etc. Thus, “high-voltage” refers to voltage levels well in excess of typical 12-15V low/auxiliary voltage levels, with 400V or more being an exemplary high-voltage level in some embodiments of the battery pack 112.

In some configurations, the electrified powertrain system 110 of FIG. 1 may include an on-board charger (OBC) 132 that is selectively connectable to an offboard charging station 133 via an input/output (I/O) block 132A during a charging mode during which the battery pack 112 is recharged by an AC charging voltage (V_{CH}) from the offboard charging station 133. The I/O block 132 is connectable to a charging port 117 on the vehicle body 122. For instance, a charging cable 135 may be connected to the charging port 117, e.g., via an SAE J1772 connection. The electrified powertrain system 110 may also be configured to selectively receive a DC charging voltage in one or more embodiments as appreciated in the art, in which case the OBC 132 would be selectively bypassed using circuitry (not shown), e.g., that may be used to charge and/or discharge the battery pack 112 gradually for performing various functions, such as testing the SOC. The OBC 132 could also operate in different modes, including a charging mode during which the OBC 132 receives the AC charging voltage (V_{CH}) from the offboard charging station 133 to recharge the battery pack 112 after a low charge indicator light displays on the dashboard, and a discharging mode, represented by arrow V_{X}, during which the OBC 132 offloads power from the battery pack 112 to an external AC electrical load (L). In this manner, the OBC 132 may embody a bidirectional charger.

Still referring to FIG. 1, the electrified powertrain system 110 may also include an electronic control unit (ECU) 134. The ECU 134 is operable for regulating ongoing operation of the electrified powertrain system 110 via transmission of electronic control signals (arrow CC_{O}). The ECU 134 does so in response to electronic input signals (arrow CC_{I}). Such input signals (arrow CCI) may be actively communicated or passively detected in different embodiments, such that the ECU 134 is operable for determining a particular mode of operation. In response, the ECU 134 controls operation of the electrified powertrain system 110. Thus, the ECU and its accompanying components may act as a BMS for performing functions including estimating the SOC, etc.

To that end, the ECU 134 may be equipped with one or more processors (P), e.g., logic circuits, combinational logic circuit(s), Application Specific Integrated Circuit(s) (ASIC), electronic circuit(s), central processing unit(s), semiconductor IC devices, etc., as well as input/output (I/O) circuit(s), appropriate signal conditioning and buffer circuitry, and other components such as a high-speed clock to provide the described SOC functionality in prior figures, as well as different functions identified by the CC input signal. The ECU 134 also includes an associated computer-readable storage medium, i.e., memory (M) inclusive of read only, programmable read only, random access, a hard drive, etc., whether resident, remote or a combination of both. Control routines, including code for executing the SOC model with hysteresis, are executed by the processor to monitor relevant inputs from sensing devices and other networked control modules (not shown), and to execute control and diagnostic routines to govern operation of the electrified powertrain system 110. The I/O circuits may be directly coupled to the ECU 134, along with memory M and one or more processors P for executing code that estimates SOC. In an aspect, the BMS system may collectively be realized as ECU 134, OBC 132 and bus 127. OBC 132 and bus 127 may be an apparatus within the BMS or included as part of the BMS that is enabled to be connected to the outer terminals of battery pack 112 to perform the functions recited herein. In some implementations, the BMS may be coupled directly with the battery pack.

EV 111 may, like other vehicles, include a dashboard implanted within or otherwise connected to the body of EV 111. The body houses a cabin where the driver and occupants reside. The apparatus discussed above may include control signals to the dashboard and conversion circuitry to enable the driver to assess the SOC remaining based on an amount or percentage of charge remaining, an estimated time that the vehicle will die or imminently needs recharging, and other data. At least some of these aspects may be computed by the BMS, including ECU 134 and its associated processor P running code from memory M. Messages may be sent via the I/O circuit to other parts of the vehicle, via CC₀ or another connection not specifically shown.

In the above example, the PIM 128 (or more simply, the PM) may include a set of semiconductor switches driven by a modulation technique such as PWM (although other suitable modulation techniques such as PDM may be used). In other configurations, the ECU or a microcontroller unit (MCU) therein (e.g., processor P) may also be used to govern the transmission of modulated signals. The semiconductor switches of PIM 128 may include power transistors, and the modulation technique used to drive them may include intermediary circuitry to suitably decode the PWM signals where needed and to adjust the rail-to-rail voltage swing from power used by logic circuits (e.g., 0 to 5 volts, or the like) to the higher voltages needed by a gate driver to switch the power transistors that drive the rotary electric machine 126. With reference to the PIM 128, a gate driver may be employed to turn the power transistors/switches on and off.

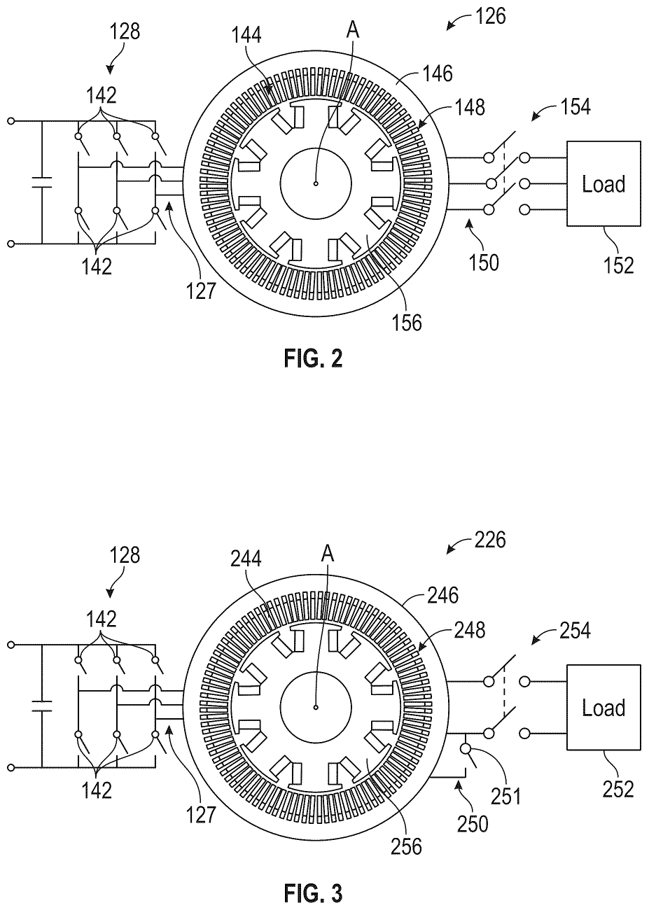

As shown in FIG. 2, high-speed switching of semiconductor switches 142 of the PIM 128 energizes the rotary electric machine 126 to thereby cause the rotary electric machine 126 to deliver the output torque. As appreciated in the art, inverters such as the PIM 128 shown in FIG. 1, utilize multiple dies of the semiconductor switches 142 as fast-responding ON/OFF switching devices, e.g., insulated gate bipolar transistors (“IGBTs”), metal oxide semiconductor field-effect transistors (“MOSFETs”), thyristors, etc. In a typical three-phase configuration of the rotary electric machine 126, the semiconductor switches 142 are turned ON or OFF at predetermined switching intervals to output an alternating current (“AC”) waveform to the rotary electric machine 126.

While the PIM 128 is energizing the rotary electric machine 126 with the alternating current through a first set of stator windings 144 that extend through a stator 146, an alternating current is generated in a second set of windings 148 in the stator 146. In the illustrated example, the first set of windings 144 are low-turn windings and the second set of windings 148 are high-turn windings. In one example, the first set of windings 144 can include between 24 and 32 turns and the second set of windings 148 can include between 192 and 320 turns, such that the second set of windings 148 includes between eight and ten times as many turns as the first set of windings 144. Furthermore, as shown in the illustrated example, the first set of windings 144 are located radially inward from the second set of stator windings 148 relative to an axis of rotation A of the rotary electric machine 126.

The second set of windings 148 are connected to an output alternating current bus 150 for transferring the alternating current generated in the second set of windings 148 to a power outlet 154 that is selectively connectable to a load 152. In this disclosure, the load can include a device that is power from the power outlet 154 or a power grid. In the illustrated example, the second set of windings 148 provide a three-phase alternating current to the load 152 through the power outlet 154. In one example, to generate the three-phase alternating current to the load 152 through the second set of windings 148, the PIM 128 utilizes the first set of windings 144 (e.g. the low-turn windings) to increase a rotational speed of a rotor 156 in the rotary electric machine 126 to match the frequency of the load 152, such as a power grid. With the second set of windings 148 connected to the load 152, the PIM 128 can utilize the first set of windings 144 to regulate power flow such that the power can flow bidirectionally between the battery pack 112 and the external sources, such as the load 152.

Furthermore, for the second set of windings 148 to provide three-phase alternating current that is synchronized with the load 152, the rotor 156 in the rotary electric machine 126 is rotated at an appropriate rotational speed to achieve the synchronization. In one example, if the rotor 156 is an eight pole rotor, then the rotor 156 will be driven by the PIM 128 to rotate at 900 RPM to match a 120 degree phase shift with the load 152. In another example, if the rotor 156 is a six pole rotor, then the rotor 156 will be driven through the PIM 128 to rotate at 1200 RPM to match the 120 degree phase shift with the load 152. The ECU 134 can also control the PIM 128 such that the active power and the reactive power produce a power factor of zero.

FIG. 3 illustrates another example rotary electric machine 226 that is in electrical communication with the PIM 128 through the AC bus 120. The rotary electric machine 226 is similar to the rotary electric machine 126 except where described below or shown in the drawings. Similar or like components between the rotary electric machine 126 and 226 will include the addition of leading “2”.

As shown in FIG. 3, the high-speed switching of semiconductor switches 142 of the PIM 128 energizes the rotary electric machine 226 to thereby cause the rotary electric machine 226 to deliver the output torque through a rotor 256. In a typical three-phase configuration of the rotary electric machine 226, the semiconductor switches 142 are turned ON or OFF at predetermined switching intervals to output an alternating current (“AC”) waveform to the rotary electric machine 226.

While the PIM 128 energizes the rotary electric machine 226 with the alternating current through a first set of stator windings 244 that extend through a stator 246, an alternating current is generated in a second set of windings 248 in the stator 146. In the illustrated example, the first set of windings 244 are low-turn windings and the second set of windings 248 are high-turn windings. In one example, the first set of windings 244 can include between 24 and 32 turns and the second set of windings 248 can include between 192 and 320 turns, such that the second set of windings 248 includes between eight and ten times as many turns as the first set of windings 144. Furthermore, as shown in the illustrated example, the first set of windings 244 are located radially inward from the second set of windings 248 relative to an axis of rotation A of the rotary electric machine 226.

The second set of windings 248 are connected to an output alternating current bus 250 for transferring the alternating current generated in the second set of windings 248 to a power outlet 254 that is selectively connectable to a load 252. In the illustrated example, the load 252 is configured to receive single-phase alternating current through the output alternating current bus 250. Also, the output alternating current bus 250 includes three sets of windings with two of the windings being connectable by a switch 251 to allow the second set of windings 248 to provide single-phase alternating current to the load 252 for the output alternating current bus 250 to be used to provide three-phase alternating current for a load, such as the load 152.

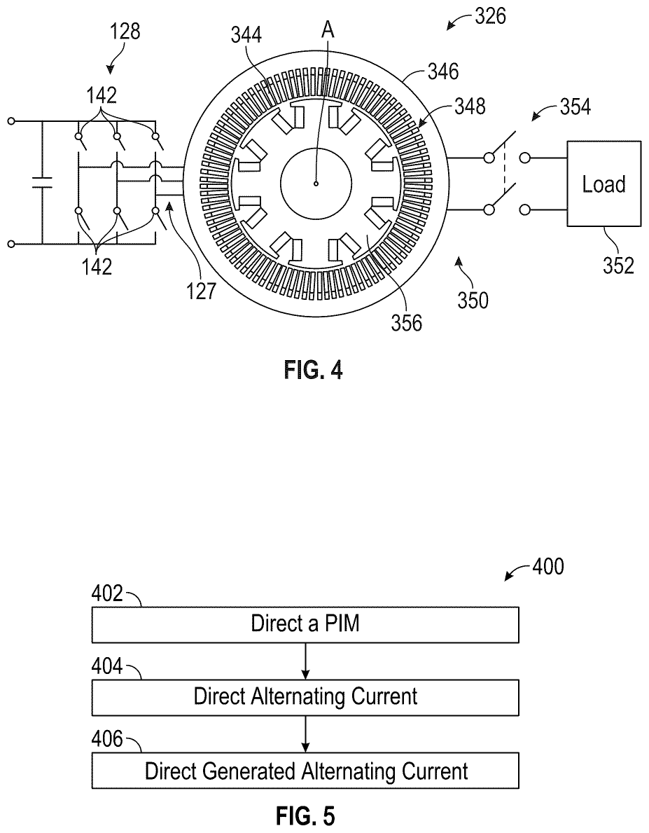

FIG. 4 illustrates another example rotary electric machine 326 that is in electrical communication with the PIM 128 through the AC bus 120. The rotary electric machine 326 is similar to the rotary electric machine 126 except where described below or shown in the drawings. Similar or like components between the rotary electric machine 126 and 326 will include the addition of leading “3”.

As shown in FIG. 4, the high-speed switching of semiconductor switches 142 of the PIM 128 energizes the rotary electric machine 326 to thereby cause the rotary electric machine 326 to deliver the output torque through a rotor 356. In a typical three-phase configuration of the rotary electric machine 326, the semiconductor switches 142 are turned ON or OFF at predetermined switching intervals to output an alternating current (“AC”) waveform to the rotary electric machine 326.

While the PIM 128 energizes the rotary electric machine 326 with the alternating current through a first set of windings 344 that extend through a stator 346, an alternating current is generated in a second set of windings 348 in the stator 346. In the illustrated example, the first set of 344 windings are low-turn windings and the second set of windings 348 are high-turn windings. In one example, the first set of windings 344 can include between 24 and 32 turns and the second set of windings 248 can include between 192 and 320 turns, such that the second set of windings 348 includes between eight and ten times as many turns as the first set of windings 344. Furthermore, as shown in the illustrated example, the first set of windings 344 are located radially inward from the second set of windings 348 relative to an axis of rotation A of the rotary electric machine 326.

The second set of windings 348 are connected to an output alternating current bus 350 for transferring the alternating current generated in the second set of windings 348 to a power outlet 354 that is selectively connectable to a load 352. In the illustrated example, the load 352 is configured to receive single-phase alternating current through the output alternating current bus 350. Also, the output alternating current bus 350 includes two outputs that correspond with two sets of windings that form the second set of windings 348.

FIG. 5 illustrates an example method 400 of operating a rotary electric machine, such as one of the rotary electric machines 126, 226, or 326, to provide a desired output power to a load 152, 252, or 352, respectively. The method 400 beings at block 402.

At block 402 (“Direct a PIM”), the method 400 directs the PIM 128 to convert direct current from the battery pack 112 from the DC bus 127 into three-phase alternating current received by the AC bus 120. In one example, the ECU sends control signals to the PIM 128 that the PIM 128 utilizes for selectively controlling the switches 142 to create a desired three-phase alternating current that drives the rotary electric machine 126. The PIM 128 generates the three-phase alternating current by selectively controlling the switches 142. With the three-phase alternating current generated by the PIM 128, the method 400 then proceeds to block 404.

At block 404 “(Direct Alternating Current”), the method 400 directs each of the three phases of the alternating current to a corresponding winding of the first set of windings 144, 244, or 344 for energizing the rotary electric machine 126, 226, or 326, respectively. By directing the three-phase alternating current into the first set of windings 144, 244, or 344 in the rotary electric machine 126, 226, or 326, respectively, a corresponding alternating current is formed in the second set of windings 148, 248, or 348.

If the alternating current generated in the second set of windings 148 or 248 is a three-phase alternating current, the method 400 disengages the rotary electric machine 126 or 226 from a drive train of the EV 111 to allow the rotor to rotate without causing the vehicle 11 to move. The method 400 directs the rotational speed of the rotor in the rotary electric machine to synchronize a frequency, amplitude, and phase of the alternating current generated in the second set of windings with a load in electrical communication with the power outlet.

With alternating current directed into the rotary electric machine 126, 226, or 326, the method 400 proceeds to block 406.

At block 406 (“Direct Generated Alternating Current”), the method 400 directs the generated alternating current from the second set of windings 148, 248, or 348 through the output alternating current bus 150, 250, or 350, respectively to the power outlet 154, 254, or 354. A load 152, 252, or 352 can be connected to the power outlet 154, 254, or 354, respectively, to receive the generated alternative current. As discussed above, one feature of generating the alternating current in the second set of windings 148, 248, or 348 is that it reduces the need for an additional power inverter module to match the power needs of one of the loads, 152, 252, or 352.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

1. A power transfer system, comprising:
a traction battery pack;
a power inverter module configured to receive a high-voltage direct current from the traction battery pack and convert the high-voltage direct current into an alternating current that is configured to be received by an alternating current bus;
a rotary electric machine in electrical communication with the alternating current bus, wherein the rotary electric machine is a segmented winding machine and includes a first set of windings in electrical communication with the alternating current bus, a second set of winding in electrical communication with an output alternating current bus, and the second set of windings is electrically isolated from the power inverter module;
a power outlet in electrical communication with the second set of windings through the output alternating current bus; and
a controller in electrical communication with the power inverter module, wherein the controller is configured to:
selectively direct the power inverter module to direct the alternating current through the alternating current bus to the rotary electric machine to generate a desired output power at the power outlet.

2. The power transfer system of claim 1, wherein the first set of windings are low-turn windings and the second set of windings are high-turn windings, the rotary electric machine includes a three-phase rotary electric machine, and the first set of windings are electrically isolated from the output alternating current bus.

3. The power transfer system of claim 1, wherein the first set of windings are located radially inward from the second set of windings in a stator of the rotary electric machine relative to an axis of rotation of a rotor in the rotary electric machine and the rotary electric machine includes a stator having plurality of teeth and a portion of the first set of windings and a portion of the second set of windings surround a corresponding one of the plurality of teeth on the stator.

4. The power transfer system of claim 3, wherein the second set of windings includes three sets of windings each having a corresponding output in electrical communication with the output alternating current bus.

5. The power transfer system of claim 4, wherein a first winding of the three sets of windings in the second set of windings is selectively connectable to the power outlet through a second windings of the second set of windings by a switch and the controller is configured to selectively actuate the switch to provide a three-phase alternating current in a first switch position or a single-phase alternating current in a second switch position through the output alternating current bus to the power outlet.

6. The power transfer system of claim 4, wherein the desired output power includes a three-phase alternating current, the output alternating current bus is a three-phase current bus, and the controller is configured to disengage a drivetrain from the rotary electric machine while the alternating current is directed through the alternating current bus to the rotary electric machine.

7. The power transfer system of claim 6, wherein the rotor is an eight pole rotor and the controller is configured to direct the rotary electric machine to rotate the rotor at 900 RPM.

8. The power transfer system of claim 6, wherein the rotor is a six pole rotor and the controller is configured to direct the rotary electric machine to rotate the rotor at 1200 RPM.

9. The power transfer system of claim 1, wherein the desired output power includes a single phase alternating current and the second set of windings includes only two sets of windings with each of the two sets of windings selectively connected to the power outlet by a corresponding switch for providing single-phase alternating current to the power outlet

10. The power transfer system of claim 1, wherein the second set of windings include between 8 and 10 times as many turns as the first set of windings.

11. A method of performing power transfer, the method comprising:
directing a power inverter module to convert direct current from a traction battery pack from a direct current bus into a three-phase alternating current received by an alternating current bus;
directing the three-phase alternating current into a rotary electric machine, wherein the rotary electric machine is a segmented winding machine and includes a first set of windings in electrical communication with the alternating current bus, a second set of winding in electrical communication with an output alternating current bus, and the first set of windings are electrically isolated from the output alternating current bus; and
directing an alternating current generated in the second set of windings through the output alternating current bus to a power outlet.

12. The method of claim 11, wherein the first set of windings are low-turn windings and the second set of windings are high-turn windings, the first set of windings are located radially inward from the second set of windings, and the rotary electric machine includes a stator having plurality of teeth and a portion of the first set of windings with a portion of the second set of windings surrounding a corresponding one of the plurality of teeth on the stator.

13. The method of claim 12, wherein the second set of windings includes three sets of windings configured to provide three-phase alternating current from each of the second set of windings to the output alternating current bus and the second set of windings are electrically isolated from the power inverter module.

14. The method of claim 13, including directing a rotational speed of a rotor in the rotary electric machine to synchronize a frequency, amplitude, and phase of the alternating current generated in the second set of windings with a load in electrical communication with the power outlet.

15. The method of claim 14, including disengaging the rotary electric machine from a drivetrain of a vehicle when directing the rotational speed of the rotor in the rotary electric machine to synchronize the frequency, amplitude, and phase of the alternating current generated in the second set of windings with the load in electrical communication with the power outlet.

16. The method of claim 12, wherein the second set of windings include three sets of windings each having a corresponding output and first winding of the three sets of windings in the second set of windings is selectively connectable to the power outlet through a second windings of the second set of windings by a switch configured to selectively provide a three-phase alternating current in a first switch position or a single-phase alternating current in a second switch position through the output alternating current bus to the power outlet.

17. A vehicle comprising:
a vehicle body supported by a plurality of wheels;
a traction battery pack fixed relative to the vehicle body;
a power inverter module configured to receive a high-voltage direct current from the traction battery pack and convert the high-voltage direct current into an alternating current that is configured to be received by an alternating current bus;
a rotary electric machine in electrical communication with the alternating current bus and configured to drive the plurality of wheels through a drivetrain, wherein the rotary electric machine is a segmented winding machine and includes a first set of windings in electrical communication with the alternating current bus and a second set of winding in electrical communication with an output alternating current bus, and the second set of windings is electrically isolated from the power inverter module;
a power outlet in electrical communication with the second set of windings through the output alternating current bus; and
a controller in electrical communication with the power inverter module, wherein the controller is configured to:
selectively direct the power inverter module to direct the alternating current through the alternating current bus to the rotary electric machine to generate a desired output power at the power outlet.

18. The vehicle of claim 17, wherein the first set of windings are low-turn windings and the second set of windings are high-turn windings, the first set of windings are located radially inward from the second set of windings in a stator of the rotary electric machine relative to an axis of rotation of a rotor in the rotary electric machine and the rotary electric machine includes a stator having plurality of teeth and a portion of the first set of windings and a portion of the second set of windings surround a corresponding one of the plurality of teeth on the stator.

19. The vehicle of claim 18, wherein the second set of windings includes three sets of windings each having a corresponding output in electrical communication with the output alternating current bus, the rotary electric machine includes a three-phase rotary electric machine, and the first set of windings are electrically isolated from the output alternating current bus.

20. The vehicle of claim 19, wherein a first winding of the three sets of windings in the second set of windings is selectively connectable to the power outlet through a second windings of the second set of windings by a switch and the controller is configured to selectively actuate the switch to provide a three-phase alternating current in a first switch position or a single-phase alternating current in a second switch position through the output alternating current bus to the power outlet.
